(19) United States
(12) Patent Application Publication
(10) Pub. No.: US 2010/0232645 A1
(43) Pub. Date: Sep. 16, 2010

(54) MODEL-BASED SPECT HEART ORIENTATION ESTIMATION

(75) Inventors: Thomas Blaffert, Hamburg (DE); Jens Von Berg, Hamburg (DE); Zuo Zhao, Palo Alto, CA (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/599,097

(22) PCT Filed: Apr. 17, 2008
(86) PCT No.: PCT/IB2008/051481

§ 371 Date: Nov. 6, 2009

Related U.S. Application Data
(60) Provisional application No. 60/917,173, filed on May 10, 2007.

(51) Int. Cl. G06K 9/00

(52) U.S. Cl. 382/103

(57) ABSTRACT

When estimating a position or orientation of a patient's heart, a mesh model of a nominal heart is overlaid on a SPECT or PET image of the patient's heart and manipulated to conform to the image of the patient's heart. A mesh adaptation protocol applies opposing forces to the mesh model to constrain the mesh model from changing shape and to pull the mesh model to the shape of the patient's heart. A heart orientation estimator (60) iterates the mesh adaptation protocol a predetermined number of times, after which it defines a long axis of the left ventricle of the patient's heart as a line passing through the center of the mitral valve and the center of mass of the left ventricle. The long axis is then employed by a reorientation processor (70) to reorient the SPECT or PET image of the patient's heart, over which the mesh model was originally laid, to improve the accuracy of the PECT or PET image.

The present application finds particular application SPECT, PET, and other nuclear imaging devices or techniques. However, it will be appreciated that the described technique(s) may also find application in other types of imaging systems and/or other patient scanning systems or techniques.

In many cardiac imaging studies, the left ventricle is of particular interest. When viewing images of the left ventricle, it is conventional to generate slices which are orthogonal to the long axis of the left ventricle. As a preliminary step in generating these images, one needs to define the long axis of the left ventricle.

One of the most important diagnostic applications of single photon emission computed tomography (SPECT) is myocardial perfusion imaging, where uptake of a tracer substance that contains a suitable radionuclide such as Tc-99m indicates the health condition of cardiac regions. With this diagnostic method, the low intensities in a SPECT image of the left ventricular (LV) area are related to perfusion defects due to coronary artery disease.

In myocardial SPECT, the transaxial images that are reconstructed from projection data can be reoriented into short-axis images. Short-axis images, which are perpendicular to the LV's long axis, allow standardization of myocardial perfusion SPECT display and interpretation, and also make it possible to present 3D information in 2D polar maps, a standard view for quantification. The long axis of the LV can be determined manually, but this is time consuming and also subjective.

One technique is to superimpose a mathematical model of an ellipsoid on the images of the left ventricle. The radiologist then adjusts this ellipsoid, such as by using drawing tools, to push and pull the ellipsoid, to conform it as accurately as possible to the patient's left ventricle. Because the long axis is typically oblique to all three of the orthogonal axes that are typically used in generating a computed tomography image, this manual operation is more difficult than it appears. Alternately, one could segment the left ventricle and use a computer-based fitting technique to fit an ellipse to the outline of the left ventricle. There is again indefiniteness in this fitting technique. Further, imaged patients often have defects which render the shape of the left ventricle other than truly ellipsoidal.

One approach for automatically determining the long axis is to fit an ellipsoid to the data and using the symmetry axis for reorientation, as described in “Automatic Reorientation of Three-Dimensional, Transaxial Myocardial Perfusion SPECT Images,” G. Germano, P. B. Kavanagh, H.-T. Su, M. Mazzanti, H. Kiat, R. Hachamovitch, K. F. Van Train, J. S. Areeda, D. S. Berman, J. Nucl. Med., 36(6), 1107-1114, 1995. Such a mathematical model, however, does not reflect asymmetries and individual anatomical variation of the heart, and usually fails to locate the long axis if a large amount of uptake defect is present. Moreover, a SPECT image often shows the right ventricle. This structure typically needs to be suppressed for the ellipsoid fit, although it can contain useful additional information for the orientation estimation, particularly if parts of the LV show low intensities due to infarction.

Thus, there is an unmet need in the art for systems and methods that facilitate overcoming the deficiencies described above.

In accordance with one aspect, a system for identifying a major axis of a left ventricle in a heart includes a reconstruction processor that receives image data of a patient's heart and reconstructs the data into an image representation, a heart orientation estimator that uses the image representation and a standard mesh model to identify the long axis of a left ventricle of the heart, and a reorientation processor further reorients the image data with the long axis as one of three orthogonal reorientation axes. The system further includes a display that presents the image information and identified long axis information to a user.

In accordance with another aspect, a method of estimating the orientation of a heart in a patient includes generating raw image data of a patient's heart, reconstructing the image data into an image representation, overlaying a predefined mesh model on the image representation, and executing a mesh adaptation protocol on the mesh model to define a long axis of the left ventricle. The method further includes reorienting the reconstructed transverse image using the defined long axis as one of three orthogonal reorientation axes.

Yet another aspect relates to a system for identifying a major axis of a left ventricle in a heart, including a reconstruction processor that receives image data of a patient's heart and reconstructs the data into an image representation, a heart orientation estimator that uses the image representation and a standard mesh model to identify the long axis of a left ventricle of the heart, a reorientation processor further reorients the image with the long axis as one of three orthogonal reorientation axes, and a display that presents the image information and identified long axis information to a user.

One advantage is that the long axis of the left ventricle is identified as a line passing through the mitral valve and the center of mass of the myocardium of the left ventricle.

Another advantage resides in improved image accuracy over conventional CT due to image reorientation the long axis information.

Still further advantages of the subject innovation will be appreciated by those of ordinary skill in the art upon reading and understand the following detailed description.

The innovation may take form in various components and arrangements of components, and in various steps and arrangements of steps. The drawings are only for purposes of illustrating various aspects and are not to be construed as limiting the invention.

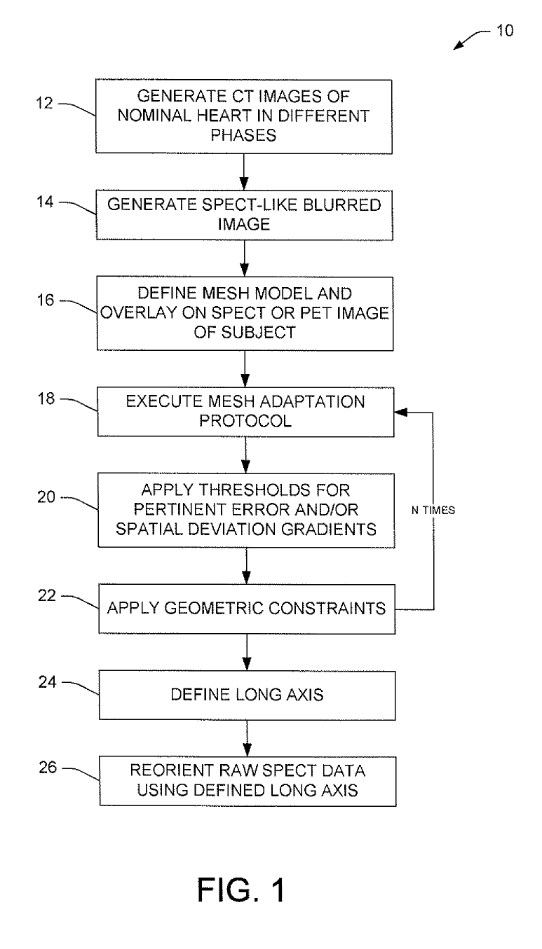

FIG. 1 illustrates a method for identifying the long axis of a left ventricle in a heart using adaptive mesh modeling.

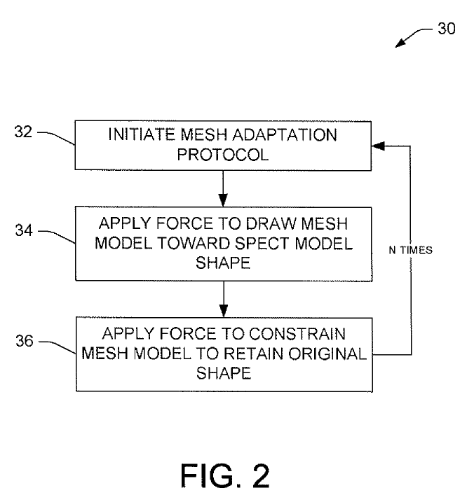

FIG. 2 illustrates a method for adapting a mesh model of a heart by applying opposing forces to the model, in accordance with one or more aspects.

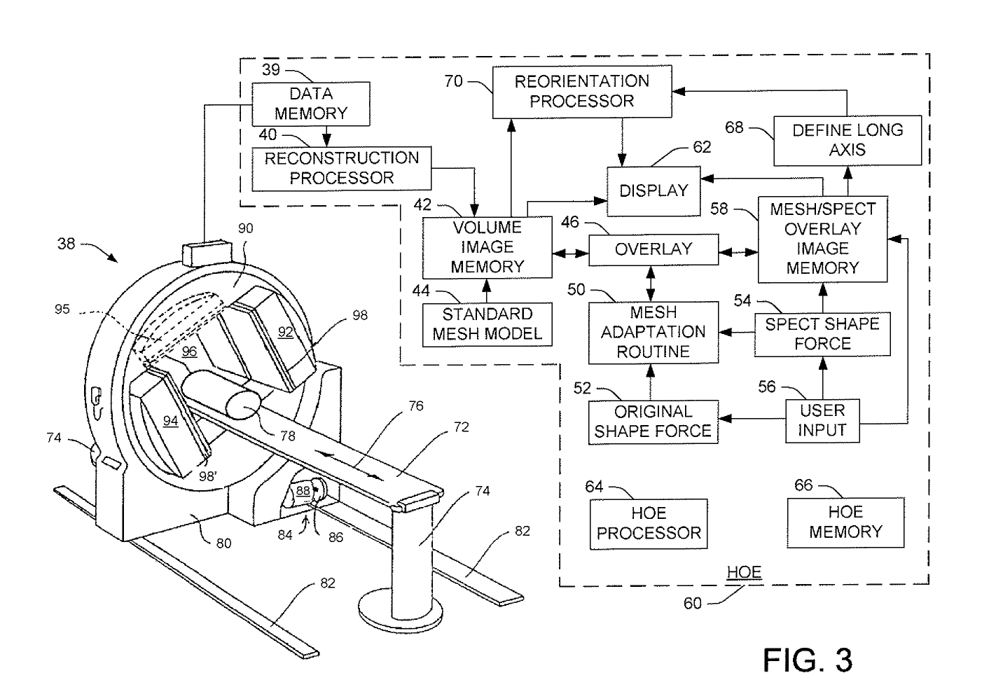

FIG. 3 illustrates a heart orientation estimation system for identifying the long axis of the left ventricle (LV) automatically, robustly, and in a well-determined manner within a single photon emission computed tomography (SPECT) image in conjunction with an imaging device, in accordance with various embodiments described herein.

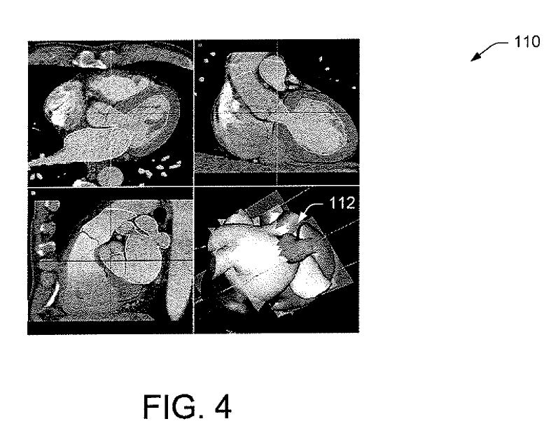

FIG. 4 shows a screenshot of various CT-image angles and a constructed 3D mesh model of a heart, generated using an approach for heart orientation estimation from SPECT images, which has the separate steps of heart model construction and heart model adaptation.

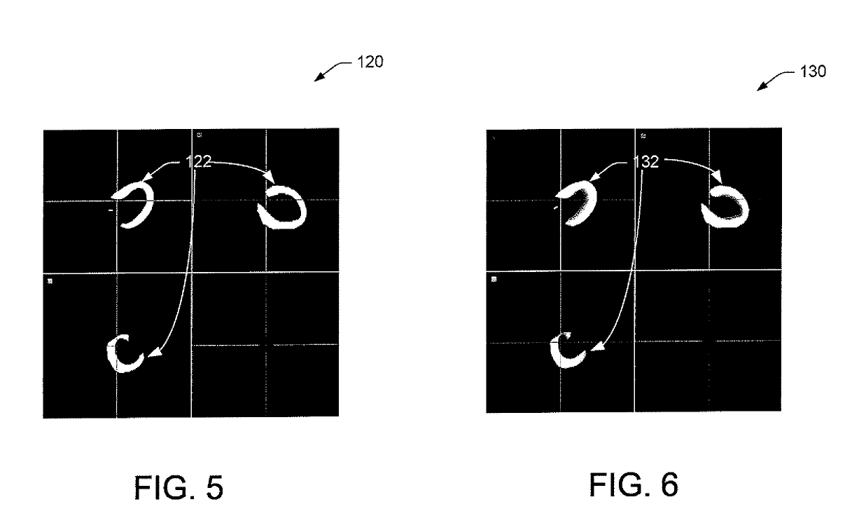

FIGS. 5 and 6 show a screenshots and of an LV volume constructed from the mesh model and an average LV volume, respectively.

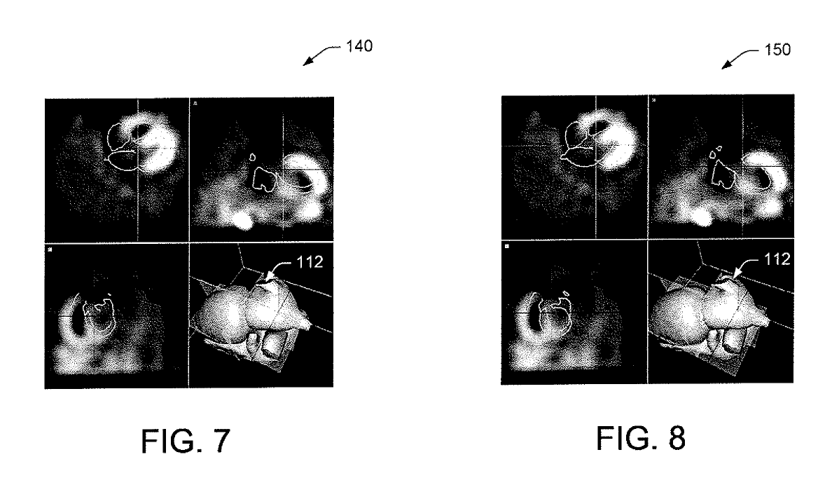

FIGS. 7 and 8 show screenshots and of the reference model as used for orientation estimation.

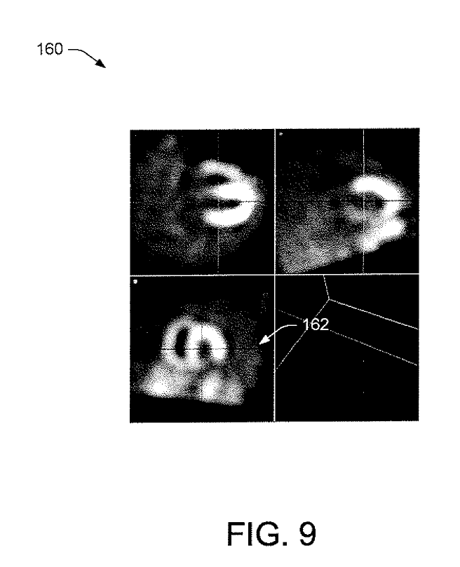

FIG. 9 is a screenshot of a re-oriented three-orthogonal-axis view of an infracted heart.

FIG. 1 illustrates a method 10 for identifying the long axis of a left ventricle in a heart using adaptive mesh modeling. At 12, CT images of a nominal or typical heart are generated in several different phases of action. For instance, a predetermined number of CT images (e.g., 5, 10, 12, or any other desired number) of the heart may be generated during a heartbeat cycle. At 14, a “SPECT-like” image is generated by combining the CT image data describing the heart or a portion thereof, such as the left ventricle, wherein the image is blurred due to the conglomeration or average of multiple different CT image volumes. The contribution of the image in each cardiac phase is weighted based on the relative time a nominal heart spends in each phase. Structures in the image that are not visible in SPECT are removed. The defined mesh model is stored in the standard mesh model memory 44.

At 16, a mesh model that corresponds to the SPECT-like image, and is overlaid on a SPECT or PET image of the patient's heart. Additionally, the SPECT image may be segmented to define its region more clearly. At 18, a mesh adaptation protocol is executed to adapt the mesh model to conform toward the SPECT-like image. For instance, the mesh model can be pulled toward the SPECT-like model image dimension while enforcing certain constraints that ensure that the mesh model is not pulled beyond a predefined acceptable threshold level. Additionally, thresholds are set for pertinent spatial deviation gradients, acceptable error levels and/or percentages, or the like, and are applied at 20. For example, a maximum gradient sets a maximum attraction of the mesh such that an artifact cannot draw (distort) the mesh too strongly. At 22, geometric limitations can be applied to prevent the mesh from being drawn into shapes that deviate too significantly from an ellipsoid. This fitting technique is iteratively repeated N times, where N is an integer and may be present according to design constraints, user preferences, or the like. In one embodiment, the number of iterations is set to approximately six. Optionally, the user can overlay the final model on the SPECT or PET diagnostic images and can manually call for further iterations of the process.

At 24, the long axis is defined, which is the axis that extends from the mitral valve through the center of mass of the ventricle volume. It will be appreciated that other models and/or definitions of the long axis may be utilized in conjunction with the various aspects and/or embodiments described herein, and that the long axis is not limited to being a line passing through the mitral valve and a center of mass of the volume of the left ventricle. Once the long axis is defined, a reorientation processor reorients the reconstructed transverse image SPECT data using the long axis as one of the three orthogonal reorientation axes, at 26. In this manner, a series of slices extending orthogonal to the long axis are generated for radiologist/cardiologist review. Optionally, if a combined SPECT-CT imaging system is used, the CT imaging system can be used to generate CT images of the heart. The previously discussed CT image-based standardized mesh model can be adapted to the patient's actual CT images, and the CT-adapted model can then be used as the starting point for the mesh adaptation process.

FIG. 2 illustrates a method 30 for adapting a mesh model of a heart by applying opposing forces to the model, in accordance with one or more aspects. According to the method, at 32, a mesh adaptation protocol is initiated. The mesh adaptation protocol is a routine similar to the routine 18 described above with regard to FIG. 1. At 34, a first force is applied to the mesh model (e.g., of a nominal or typical heart) to draw the model toward a shape of a SPECT model of the patient's heart. Concurrently, at 36, a second force is applied to the mesh model to retain the original shape of the mesh model. The balance between these two forces can be adjusted manually to optimize results. Additionally or alternatively, the relationship between these two forces can be preset during manufacture or configuration of a system utilizing the method, and may be adjustable by the user, if desired.

FIG. 3 illustrates an example of a heart orientation estimation (HOE) system for identifying the long axis of the left ventricle (LV) automatically, robustly, and in a well-determined manner within single photon emission computed tomography (SPECT) image in conjunction with an imaging device, in accordance with various embodiments described herein. It will be appreciated that the system is presented for illustrative purposes only and is not intended to limit the scope of the aspects and/or features described herein. Short-axis images, which are perpendicular to the left ventricle (LV)'s long axis, allow standardization of myocardial perfusion SPECT display and interpretation. The long axis of the LV can be determined manually, but such determination is time consuming and subjective. Accordingly, long axis determination is achieved by the systems and methods described herein by fitting a geometric mesh model, which was previously constructed from CT data, to the SPECT image, and viewing the long axis of the transformed model. When the model is constructed from multi-phase CT data, the approach permits a correction of blurring and an estimation of heart motion.

The system employs a modeling algorithm that facilitates accurately identifying the long axis of the LV in cases where general heart position has been roughly identified, such as by the method described in U.S. Provisional Patent Application No. 60/747,453 to Blaffert et al. An approach for SPECT heart orientation estimation that fits a geometric mesh model, which is constructed from CT data, to the SPECT heart image is described herein. The transformation of a defined model long axis to the fitted model gives the long axis of the heart. A model that is constructed from multi-phase CT data matches the SPECT image blurring due to heart motion. The following paragraphs provide insight into the operation and structure of an example of a system with which an automatic long axis determination algorithm is employed, such as a SPECT or PET system.

A diagnostic imaging apparatus 38 includes a subject support 72, such as a table or couch, which is mounted to stationary supports 74 at opposite ends. The table 72 is selectively movable up and down to facilitate positioning a subject 78 being imaged or examined at a desired location, e.g., so that regions of interest are centered about a longitudinal axis 76.

An outer gantry structure 80 is movably mounted on tracks 82 which extend parallel to the longitudinal axis 76. An outer gantry structure moving assembly 84 is provided for selectively moving the outer gantry structure 80 along the tracks 82 on a path parallel to the longitudinal axis 76. In the illustrated embodiment, the longitudinal moving assembly includes drive wheels 86 for supporting the outer gantry structure 80 on the tracks 82. A motive power source 88, such as a motor, selectively drives one of the wheels which frictionally engages the track 82 and drives the outer gantry structure 80 and supported inner gantry 90 and the detector heads 82 and 84 along the track(s). Alternatively, the outer gantry structure 80 is stationary and the subject support 72 is configured to move the subject 78 along the longitudinal axis 76 to achieve the desired positioning of the subject 78.

An inner gantry structure 90 is rotatably mounted on the outer gantry structure 80 for stepped or continuous rotation. The rotating inner gantry structure 90 defines a subject-receiving aperture 96. One or more detector heads, preferably two or three, are individually positionable on the rotatable inner gantry 90. The illustrated embodiment includes detector heads 92, 94, and optionally a third detector head 95. The detector heads also rotate as a group about the subject-receiving aperture 96 and the subject 16, when received, with the rotation of the rotating gantry structure 90. The detector heads are radially, circumferentially, and laterally adjustable to vary their distance from the subject 78 and spacing on the rotating gantry 90 to position the detector heads in any of a variety of angular orientations about, and displacements from, the central axis. For example, separate translation devices, such as motors and drive assemblies, are provided to independently translate the detector heads radially, circumferentially, and laterally in directions tangential to the subject receiving aperture 36 along linear tracks or other appropriate guides. The embodiments described herein employing two detector heads can be implemented on a two detector system or a three detector system, etc. Likewise, the use of three-fold symmetry to adapt the illustrated embodiments to a three detector system is also contemplated.

The detector heads 92, 94, and 95 each include a scintillation crystal, such as a single large or segmented doped sodium iodide crystal, disposed behind a radiation receiving face 98, 98′ that faces the subject receiving aperture 96. The scintillation crystal emits a flash of light or photons in response to incident radiation. The scintillation crystal is viewed by an array of photodetectors that receive the light flashes and converts them into electrical signals. A resolver circuit resolves the x, y-coordinates of each flash of light and the energy (z) of the incident radiation. That is, radiation strikes the scintillation crystal causing the scintillation crystal to scintillate, e.g., emit light photons in response to the radiation. The relative outputs of the photodetectors are processed and corrected in conventional fashion to generate an output signal indicative of (i) a position coordinate on the detector head at which each radiation event is received, and (ii) an energy of each event. The energy is used to differentiate between various types of radiation such as multiple emission radiation sources, stray and secondary emission radiation, scattered radiation, transmission radiation, and to eliminate noise.

In SPECT imaging, a projection image representation is defined by the radiation data received at each coordinate on the detector head. In SPECT imaging, a collimator defines the rays along which radiation is received. It will be appreciated that although various embodiments are described with regard to SPECT images, positron emission tomography (PET) imaging systems can additionally or alternatively be employed to perform the long axis determination techniques presented herein.

In PET imaging, the detector head outputs are monitored for coincident radiation events on two heads. From the position and orientation of the heads and the location on the faces at which the coincident radiation is received, a ray between the coincident event detection points is calculated. This ray defines a line along which the radiation event occurred. In both PET and SPECT, the radiation data from a multiplicity of angular orientations of the heads is stored to data memory 39, and then reconstructed by a reconstruction processor 40 into a transverse volumetric image representation of the region of interest, which is stored in a volume image memory 42.

The system additionally comprises the heart orientation estimator (HOE) 60 that performs the algorithms described above with regard to FIGS. 1 and 2. For instance, the HOE receives image information from the detector heads, analyzes the received information, and provides image information to a display 62 for viewing by a user. The HOE additionally includes a main processor 64 that processes received information and a main memory 66 that stores received information, processed information, reconstructed image data, one or more algorithms for processing, generating, reconstructing, etc., image data, one or more algorithms for identifying the long axis of the left ventricle, and the like.

According to an embodiment, the HOE 60 and associated components find the long axis of the left ventricle of a patient's heart using adaptive mesh modeling. For example, the HOE includes the data memory 39 and the reconstruction processor 40, which reconstructs SPECT images stored in the memory 39 into a transverse image volume data set, which in turn is stored in the volume image memory 42. A standard mesh model 44 of a nominal heart is generated, which will be used as the starting point for all patients. To generate this model, CT images are generated of a nominal heart in each of a plurality of phases (e.g., 10, 12, etc.). While conventional CT images can generate accurate images in each selected phase, SPECT and PET images are blurred over all cardiac phases. Accordingly, the contribution that each of the phases will make in a SPECT type image is determined, and a “SPECT-like” blurred image is generated, which is an image that is generated by averaging multiple CT images of the heart in different phases. Any structure in this image that is not visible in SPECT is removed. In this manner, the standard mesh model is generated and stored in the standard mesh model memory 44.

This pre-generated mesh model is overlaid 46 on the SPECT (or PET) image from the subject. In some embodiments, the SPECT image is segmented to define its region more clearly. The HOE (and/or associated processor) then executes a mesh adaptation computer routine 50, which mathematically applies two forces to the mesh model. The first force 52 draws the mesh model to the SPECT shape. The second force 54 constrains the mesh model to try to retain its original shape. The balance between these two forces can be adjusted manually with a user input device 56 to optimize results. Additionally, the HOE can be pre-configured to have a preset default relationship between these two forces.

According to an example, the first force draws the nominal heart mesh model to the shape of the patient's heart as imaged in the SPECT image. The algorithm for applying the first force utilizes various landmarks in the image in order to draw the mesh model in one or more appropriate directions. For instance, the atria of the heart are typically much darker than other areas, and can thus be easily identified. Using the atria as landmarks, the mesh model can be pulled or otherwise manipulated until the structures of the mesh model align to the structures in the SPECT image. Other identifiable heart structures (e.g., aorta, ventricles, vena cava, pulmonary vein, carotid artery, valves, etc.) can be utilized in a similar manner to match the shape of the mesh model to the SPECT (or PET) image of the patient's heart.

Thresholds can be set to define pertinent error or spatial deviation gradients. For example, a maximum gradient sets a maximum attraction of the mesh such that an artifact cannot draw (distort) the mesh too strongly. Further, geometric limitations can be set to prevent the mesh from being drawn into shapes that deviate too significantly from an ellipsoid. The fitting technique is iteratively repeated, and the number of iterations can be predefined (e.g., 4, 5, 6, etc.). The overlaid mesh/SPECT image is stored in a memory 58 and displayed to a user on display 62. Optionally, the user can manually call for further iterations of the process using drawing tools associated with the user input.

At the end of the process, the long axis is defined 68, such as the axis that extends from the mitral valve through the center of mass of the ventricle volume. Once the long axis is defined, a reorientation processor 70 reorients the transverse image SPECT data in memory 42 using the long axis as one of the three orthogonal reorientation axes. In this manner, a series of slices extending orthogonally to the long axis are generated for output to the display 62 for radiologist/cardiologist review. According to a related embodiment wherein a combined SPECT-CT imaging system is used, the CT imaging system can be employed to generate CT images of the heart. The previously discussed CT image-based mesh model can then be adapted to the patient's actual CT images. The CT-adapted model can then be used as the starting point for the mesh adaptation process.

FIG. 4 shows a screenshot 110 of various CT-image angles and a constructed 3D mesh model 112 of a heart, which is generated using an approach for heart orientation estimation that is typically employed for SPECT images, wherein the approach has the separate steps of heart model construction and heart model adaptation. The model of an average heart is constructed from CT data as a geometric triangle mesh, as described in “A comprehensive geometric model of the heart,” C. Lorenz, J. von Berg, Medical Image Analysis 10 pp. 657-670, 2006. From multi-phase CT data it is possible to derive an average heart motion, as described in “A whole heart mean model built from multi-phase MSCT data,” C. Lorenz, J. von Berg, In Frangi, Delingette (Eds.) MICCAI workshop proceedings “From Statistical Atlases to Personalized Models: Understanding Complex Diseases in Populations and Individuals”, 2006 p. 83-86. For the purpose of SPECT data evaluation, this model may be restricted to the left and right ventricle and optionally the left and right atrium or other cardiac structures for reference purposes.

FIGS. 5 and 6 show a screenshots 120 and 130 of an LV volume constructed from the mesh model and an average LV volume, respectively. For each phase of the heart motion, a volume data set with the shape of the LV 122 is derived, which resembles a “simulated” set of SPECT images from an average heart. An average LV volume 132, derived from the multi-phase data set, resembles a SPECT image blurred by heart motion. Additionally, the image may be convolved with the point-spread function of the SPECT scanner in order to simulate the blurring caused by acquisition. The average model is then fitted to the “blurred” data set, giving the final reference model for SPECT data adaptation. The refined model has an advantage over the unprocessed CT model in that its shape is closer to the measured SPECT data and is thus more robust in adaptation. Finally, a long axis is defined for the model, e.g. a line through the center of the mitral valve and the center of mass of the myocardium, estimated by an averaged location of surface model vertices.

FIGS. 7 and 8 show screenshots 140 and 150 of the reference model as used for orientation estimation. The initial position and size of the reference model 112 is used for orientation estimation by first positioning it roughly within a measured SPECT data set, as shown in screenshot 140. The model is then adapted to the data by moving the mesh triangles iteratively towards gradients in their neighborhood, as shown in screenshot 150.

FIG. 9 is a screenshot 160 of three reoriented orthogonal axis views of an infracted heart 162. From the location of the adapted model vertices, the long axis of the actual heart image is calculated and the three-orthogonal-axis view is obtained. Since the deformation of the SPECT reference model from the CT models is known, the impact of blurring and heart motion can be estimated with a backward transform. The algorithm for performing the orientation estimation can be employed in any myocardial SPECT reconstruction and processing software, in order to facilitate providing the functionality described herein.

1. A system for identifying a major axis of a left ventricle in a heart, including:
a reconstruction processor that receives image data of a patient's heart and reconstructs the data into an image representation;
a heart orientation estimator that uses the image representation and a predefined mesh model to identify the long axis of a left ventricle of the heart;
a reorientation processor that further reorients the image data with the long axis as one of three orthogonal reorientation axes; and
a display that presents the image information and identified long axis information to a user.

2. (canceled)

3. The system according to claim 1, wherein the heart orientation processor overlays the predefined mesh model on at least one of a single photon emission tomography (SPECT) image of the patient's heart or a positron emission tomography (PET) image of the patient's heart.

4. The system according to claim 3, wherein the heart orientation processor executes a mesh adaptation routine that applies two opposing forces to the mesh model.

5. The system according to claim 4, wherein a first force draws the mesh model toward a shape of the left ventricle in the SPECT or PET image.

6. The system according to claim 5, wherein a second force constrains the mesh model from deviating from its original shape.

7. The system according to claim 6, wherein the heart orientation processor includes at least one threshold value that limits an amount of distortion that is applied to the mesh model.

8. (canceled)

9. (canceled)

10. The system according to claim 1, wherein the heart orientation processor includes:
a routine or means for overlaying the mesh model on a SPECT or PET image representation of a patient's heart;
a routine or means for executing a mesh model adaptation protocol;
a routine or means for applying thresholds for error and/or spatial deviation gradients;
a routine or means for applying geometric constraints;
a routine or means for defining the long axis of the left ventricle; and
a routine or means for reorienting the SPECT or PET image of the patient's heart using the defined long axis.

11. A method for performing the heart orientation estimation in the system of claim 1, including:
generating a SPECT or PET image representation from the image data;
overlaying the predefined mesh model on the SPECT or PET image representation of a patient's heart;
executing a mesh model adaptation protocol including:
applying thresholds for error and/or spatial deviation gradients;
applying geometric constraints;
defining the long axis of the left ventricle; and
reorienting the SPECT or PET image representation using the defined long axis.

12. The system according to claim 1, further including:
a diagnostic imaging apparatus that generates the image data of the patient's heart.

13. A method of estimating the orientation of a heart in a patient, including:
reconstructing raw image data of a patient's heart into an image representation;
overlaying a predefined mesh model on the image representation;
executing a mesh model adaptation protocol on the mesh model to define a long axis of the left ventricle; and
reorienting the image representation using the defined long axis as one of three orthogonal reorientation axes.

14. The method according to claim 13, further including applying a first force to apply thresholds for error and/or spatial deviation gradients, and to apply geometric constraints, to draw the mesh model toward the SPECT or PET image shape.

15. The method according to claim 14, further including applying a second force to constrain the mesh model to retain its original shape.

16. The method according to claim 15, further including permitting a user to adjust a magnitude of the first and second forces relative to each other.

17. (canceled)

18. The method according to claim 13, further including presetting a number of iterations of the mesh adaptation protocol and permitting a user to adjust the preset number of iterations of the mesh adaptation protocol.

19. (canceled)

20. A processor or computer-readable medium storing a computer program for performing the method of claim 3.

21. A heart orientation estimation system, including:
a processor or means for overlaying the predefined mesh model according to claim 24 on a SPECT or PET image of a patient's heart;
a processor or means for executing a mesh adaptation protocol;
a processor or means for defining a long axis of the left ventricle;
a processor or means for reorienting the SPECT or PET image such that the long axis is aligned with an axis of the SPECT or PET image as displayed on a display.

22. The system according to claim 1, wherein the predefined mesh model is generated by:
generating CT images of a nominal or typical heart in a plurality of cardiac phases;
combining portions of the CT images corresponding to the left ventricle in the plurality of cardiac phases with a contribution of each portion weighted based on a relative time a nominal heart spends in each cardiac phase to generate the predefined mesh model.

23. The method according to claim 8, further including generating the predefined mesh model by:
generating CT images of a nominal or typical heart in a plurality of cardiac phases;
combining portions of the CT images corresponding to the left ventricle in the plurality of cardiac phases with a contribution of each portion weighted based on a relative time a nominal heart spends in each cardiac phase to generate the predefined mesh model.

24. A predefined mesh model of a left ventricle generated by:
generating CT images of a nominal or typical heart in a plurality of cardiac phases;
combining portions of the CT images corresponding to the left ventricle in the plurality of cardiac phases with a contribution of each portion weighted based on a relative time a nominal heart spends in each cardiac phase to generate the predefined mesh model.

25. The system according to claim 21, wherein the processor or means for executing the mesh adaptation protocol applies:
a first force that draws the mesh model toward a shape of the left ventricle in the SPECT or PET image;
a second force that constrains the mesh model to retain its shape;
geometric constraints; and
thresholds for error and/or spatial deviation gradients.
